(19) United States
(12) Patent Application Publication
(10) Pub. No.: US 2022/0083948 A1
(43) Pub. Date: Mar. 17, 2022

(54) METHOD FOR MONITORING NON-COMPLIANT BEHAVIOR OF EMPLOYEES WITHIN A DISTRIBUTED WORKFORCE

(71) Applicant: BroadPath, Inc., Tucson, AZ (US)

(72) Inventors: Jerry Daron Robertson, Tucson, AZ (US); Donald Gerard Hubman, Tucson, AZ (US); Kristen Olivia Dell, Tucson, AZ (US); Robert Yadao Imperio, Tucson, AZ (US)

(21) Appl. No.: 17/472,154

(22) Filed: Sep. 10, 2021

Related U.S. Application Data
(60) Provisional application No. 63/077,540, filed on Sep. 11, 2020.

(51) Int. Cl. G06Q 10/06; G06K 9/00

(52) U.S. Cl. CPC G06Q 10/06398; G06K 9/00335; G06Q 10/0635

(57) ABSTRACT

One variation of a method for monitoring non-compliant behaviors of employees in a distributed workforce includes, during a work period: accessing a video feed of a user captured by a camera coupled to a computing device operated by the user; at a first time during the work period, extracting a set of features from a subset of frames of the video feed; detecting an instance of non-compliant behavior based on the set of features; identifying a type of non-compliant behavior associated with the instance of non-compliant behavior; accessing a type of content rendered on a display of the computing device during the instance of non-compliant behavior; characterizing a risk score for the instance of non-compliant behavior based on the type of non-compliant behavior and the type of content; and, in response to the risk score exceeding a threshold risk, flagging the instance of non-compliant behavior for investigation.

### CROSS-REFERENCE TO RELATED APPLICATIONS

This application claims the benefit of U.S. Provisional Application No. 63/077,540, filed on 11 Sep. 2020, which is incorporated in its entirety by this reference.

### TECHNICAL FIELD

This invention relates generally to the field of telecommunications and more specifically to a new and useful method for monitoring non-compliant behaviors of employees in a distributed workforce in the field of telecommunications.

### BRIEF DESCRIPTION OF THE FIGURES

FIG. 1 is a flowchart representation of a first method; and

FIG. 2 is a flowchart representation of the first method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

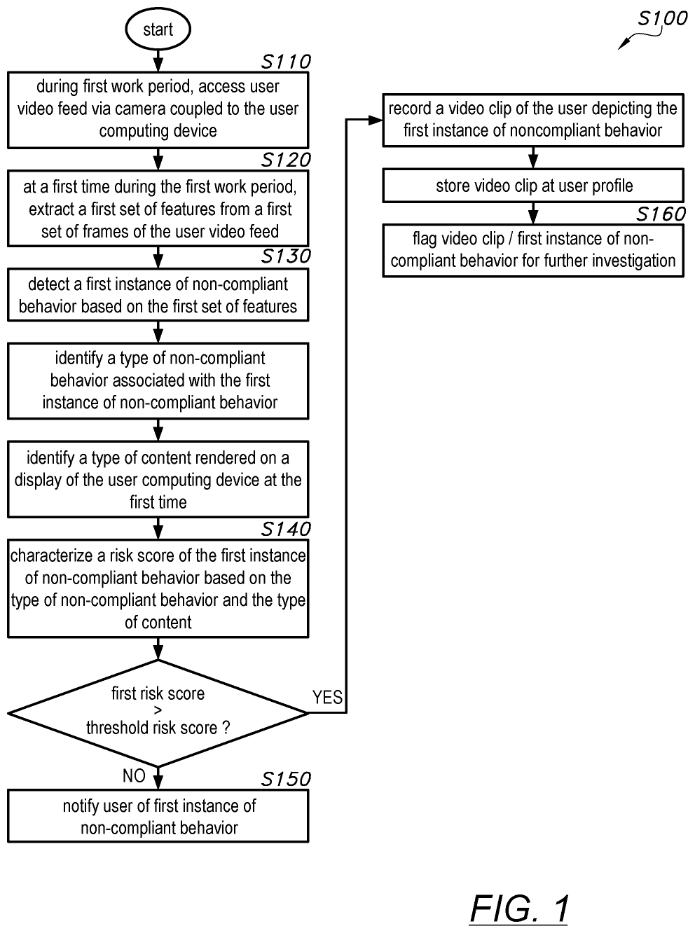

As shown in FIG. 1, a method S100 for monitoring non-compliant behaviors of employees in a distributed workforce includes: during a work period, accessing a video feed of a user captured by a camera coupled to a computing device operated by the user in Block Silo; at a first time during the work period, extracting a first set of features from a first subset of frames of the video feed in Block S120; detecting a first instance of non-compliant behavior based on the first set of features extracted from the first set of frames in Block S130; identifying a type of non-compliant behavior associated with the first instance of non-compliant behavior in Block S132; accessing a set of content characteristics representing a type of content rendered on a display of the computing device during the first instance of non-compliant behavior in Block S134; characterizing a risk score of the first instance of non-compliant behavior based on the type of non-compliant behavior and the type of content rendered on the display in Block S140; in response to the risk score falling below a threshold risk, transmitting a warning to the user regarding the first instance of the non-compliant behavior in Block S150; and, in response to the risk score exceeding the threshold risk, flagging the first instance of non-compliant behavior for investigation in Block S160.

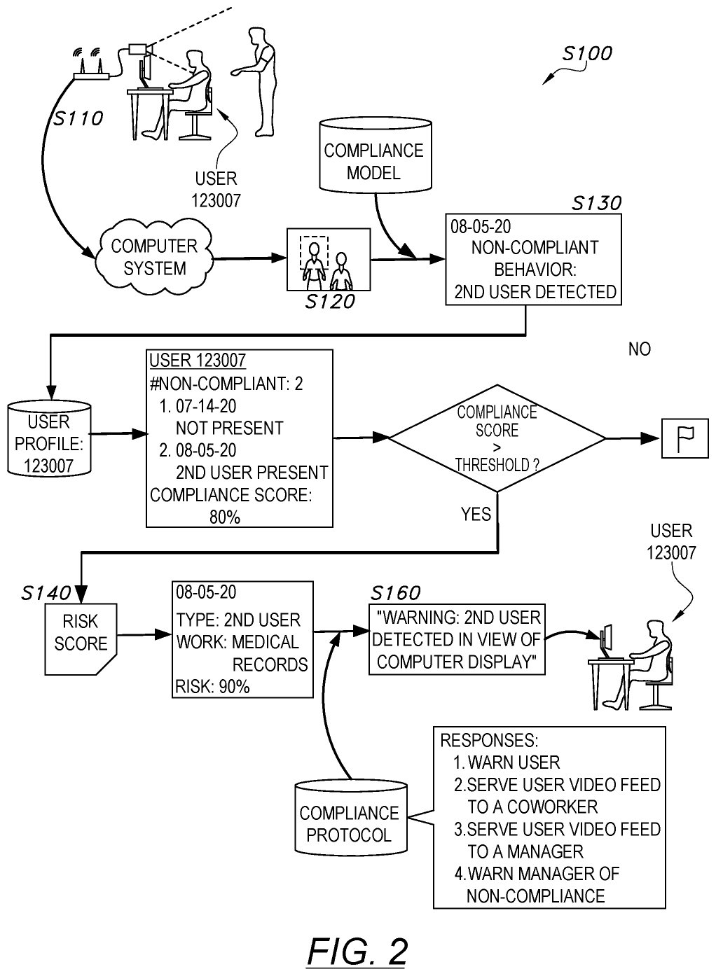

In one variation, as shown in FIG. 2, the method S100 further includes, in response to detecting the first instance of non-compliant behavior: accessing a user profile associated with the user; extracting a compliance score of the user representing user compliance within a preceding period of time; updating the compliance score based on the first instance of non-compliant behavior; and, in response to the compliance score falling below a threshold compliance, flagging the user for further investigation.

### 2. Applications

Generally, the method S100 can be executed by a computer system (e.g., a computer network, a local or remote server) to monitor a video feed of an employee within a distributed workforce and to detect non-compliant behaviors—such as behaviors associated with increased security risks, reduction in employee productivity, and/or reduction in quality of work of the employee—based on features detected in this video feed. More specifically, the computer system can continuously or intermittently access a video feed of an employee (hereinafter the “user”) to check for instances of non-compliant behavior (e.g., absence of the user, presence of a second human in the video feed, the user operating her personal mobile device for an extended period of time) and intelligently address these instances of non-compliant behavior according to importance and/or risk, such as by automatically: serving a warning to the user; scheduling compliance retraining for the user; serving a warning to the user's manager, and/or capturing a video snippet of this non-compliant event and queuing review of this video snippet by a workplace security administrator.

Furthermore, the computer system can intelligently escalate its response to detection of instances of non-compliant behavior for a particular user, such as based on both risk of a singular non-compliant event and the user's history of non-compliant events, thereby enabling the user to build trust in the computer system and enabling the user to remedy non-compliant behaviors before the computer system reports the user to a manager and/or workplace security administrator. Therefore, the computer system can track compliant and/or non-compliant behavior of the user over time and leverage this data to inform responses to future instances of non-compliant behavior. For example, at a first time, in response to detecting a first instance of non-compliant behavior for a user, the computer system can transmit a warning to the user detailing the first instance of non-compliant behavior. Later, at a second time, the computer system can recheck a video feed of the user to confirm termination of the non-compliant behavior. However, in response to detecting a second instance of non-compliant behavior for the user at the second time, the computer system can again transmit a warning to the user and also serve the video feed of the user to a subset of users (e.g., a subset of coworkers) associated with the user. If, at a third time, the computer system detects a third instance of non-compliant behavior of the user, the computer system can: flag this user for further investigation; serve the video feed of the user to her manager; and/or increase a frequency of compliant behavior checks for this user. Therefore, the computer system can enable the user to correct non-compliant behaviors while ensuring these behaviors do not persist. Further, the computer system enables the manager to prioritize dedication of resources to users exhibiting repeat instances of non-compliant behavior.

In one implementation, the computer system can characterize risk associated with an instance of non-compliant behavior and therefore distinguish between higher-priority and lower-priority instances of non-compliant behavior. In order to characterize risk (or “a risk score”) the computer system can identify whether the user's work (e.g., during an instance of non-compliant behavior) is sensitive information and/or whether a detected instance of non-compliant behavior poses a risk to the user's work. For example, in response to detecting an instance of non-compliant behavior within the video feed of the user, the computer system can: access a set of content characteristics corresponding to a type of content rendered on a display of a computing device accessed by the user; identify a type of non-compliant behavior associated with the instance of non-compliant behavior; and characterize a risk score of the instance of non-compliant behavior based on the set of content characteristics (e.g., the type of content) and the type of non-compliant behavior. Based on this risk score, the computer system can select a response tailored to the instance of the non-compliant behavior, such as warning the user if the risk score is less than a threshold risk and warning the user's manager if the risk score exceeds the threshold risk.

The computer system can therefore execute Blocks of the method S100 to: reduce instances of non-compliant behavior by employees within the distributed workforce; minimize privacy concerns of employees by periodically confirming compliant behavior; increase employee trust in the computer system by enabling employees to monitor and/or remedy their own behavior; increase trust and/or confidence of managers in their employees while working remotely; and prioritize resources spent investigating non-compliant behavior of employees.

### 3. Camera System

Generally, Blocks of the method S100 are described herein as executed locally by the user's computer system (e.g., a laptop or desktop computer). However, Blocks of the method can additionally or alternatively be executed remotely by a remote computer system, such as by a computer network or remote server that accesses and processes live video feeds inbound from laptop and desktop computers operated by a group of employees within a workforce.

The method S100 is described herein as executed by a computer system, such as a cloud-based computer, a mainframe computer system, a grid-computer system, or any other suitable computer system in the form of a remote server. As described in U.S. patent application Ser. No. 16/735,530, filed on 6 Jan. 2020—which is incorporated in its entirety by this reference—the computer system can interface with multiple manager computing devices and employee computing devices over a computer network (e.g., the Internet) to form a network of employee and manager computing devices. The network of employee and manager computing devices can also interface with a server (remote or local) to store video feeds or subsets of video feeds distributed across the network of employee and manager computing devices.

The computer system can interface with a digital camera—arranged within an employee's office or a manager's office—over a computer network (e.g., the Internet) to collect a (real-time or live) employee video feed of the employee working remotely. For example, an employee within a distributed workforce can be provided a digital camera including a discrete webcam, and the employee can manually position her webcam within her private office, such that the employee's computer monitor, desk, and task chair fall within the field of view of the camera. Once the webcam is connected to an internal router or to the employee's computer, the computer system can collect a video feed from the webcam. Alternatively, the computer system can interface with a camera integrated into the employee's (or manager's) computing device, such as a forward-facing camera integrated into the employee's laptop computer or into the employee's computer monitor.

In one implementation in which employees within a company handle private or sensitive information, an employee can be assigned a camera exhibiting a maximum resolution insufficient to enable a human or computer system to resolve sensitive information—displayed on a monitor within the employee's office—from frames recorded by the camera given a specified installation distance between the camera and the monitor and given typical employee viewing conditions for such content.

The computer system can serve employee video feeds (and other related employee data) to employees via instances of an employee portal, to a manager via a manager portal, and/or to a client representative via a client portal. Additionally, the computer system can serve manager video feeds to employees via instances of an employee portal and/or to a client via a client portal. For example, an employee can access an instance of the employee portal through a web browser or through a dedicated application executing on an Internet-connected computing device (e.g., a desktop computer, a laptop computer, a smartphone, or a tablet computer). A manager and a client representative may similarly access a manager portal and a client portal, respectively, through a web browser or dedicated application executing on corresponding manager and client computing devices.

Block S110 of the method S100 recites accessing a video feed from a camera coupled to a computing device accessed by a user and executing an instance of an employee portal. Generally, in Block S110, the computer system can access a video feed from a camera arranged within a private office of an employee within a company's distributed workforce. For example, a camera assigned to an employee (i.e., coupled to a computing device of the employee) can capture and upload a continuous live video feed to the computer system via an Internet connection during work hours. Furthermore, the computer system can simultaneously collect video feeds from cameras assigned to multiple employees within a company or within a group (or set of employees) within a company.

### 4. Local Computing Device

In one implementation, the user's local computing device (e.g., a laptop computer, a desktop computer) executes Blocks of the method S100 locally to detect and handle non-compliant events involving the user. For example, during operation, the local computing device can: access a live video feed from a camera facing the user (e.g., a forward-facing camera connected to or integrated into a computer monitor and/or a side-facing camera arranged nearby and perpendicular to the forward-facing camera); and write this live video feed to a buffer, such as a thirty-second rolling buffer. The local computing device can then implement artificial intelligence and/or computer vision techniques to scan the live video feed (e.g., every frame or intermittent frames) for non-compliant event indicators, such as: a second face; a smartphone or other mobile device; or a notepad in the video feed. The local computing device can concurrently host a portal to a virtual working environment through which the user may access sensitive work-related data and documents (e.g., insurance claim documentation, electronic medical records). The local computing device can: thus monitor types of data and documents displayed to the user over time; compare these types of data and documents to non-compliant event indicators derived from the live video feed in order to identify non-compliant event; and thus characterize (or “score”) risk for a non-compliant events based on types of data and documents concurrently displayed to the user.

Furthermore, upon detecting the non-compliant event, the computer system can: write contents of the rolling buffer to a new video file; append subsequent frames from the live video feed to the new video file while monitoring these frames for features indicative of conclusion of the non-compliant event (e.g., removal of second face or a smartphone facing the display); close the new video file upon detecting conclusion of the non-compliant event; tag or annotate this new video file (or a form associated with this new video file) with descriptions or links to the content displayed to the user during this non-compliant event; tag this new video file (or the form associated with this new video file) with a risk score calculated for the non-compliant event; and then upload this new video file (and the related form) to a remote computer system. The remote computer system can then: store this new video file (and the related form) in a non-compliant event database; and queue a workplace security administrator to review the video file and asses the non-compliant event, such as if the risk score calculated for the non-compliant event exceeds a threshold score. Later, the workplace security administrator may access the video file through a review portal, which can playback the video file; retrieve descriptions, filenames, or electronic copies of documents displayed to the user during the non-compliant event; and present these descriptions, filenames, or documents, thereby enabling the workplace security administrator to review an authentic recreation of the non-compliant event and then execute an informed corrective action.

Conversely, during operation, the user's local computing device can: capture a live video feed from the connected camera(s); upload this live video feed (e.g., at 30 frames per second) or a subset of frames (e.g., one frame per second for a 3o-frame-per-second video feed) to the remote computer system; and transmit a stream of types, descriptions, filenames, etc. of documents presented to the user. The remote computer system can then remotely execute the foregoing methods and techniques to: store the video feed in a remote buffer; detect a non-compliant event; generate a record with video file of the non-compliant event; characterize risk of the non-compliant event based on types, descriptions, filenames, etc. of documents presented to the user during this non-compliant event; and then queue a workplace security administrator to review this non-compliant event accordingly.

### 5. Verifying Camera Setup

In one implementation, the computer system can verify a camera setup of the user such that the computer system can accurately detect the user in the video feed and/or instances of non-compliant behavior. For example, the computer system can access a set of image parameters such as: a position of the camera relative the user; an angle of the camera relative the user's face (e.g., in pitch, yaw, and/or roll); a size of the viewing area (e.g., level of zoom of the camera); a resolution of the video feed; a visibility of the user and the user's surroundings (e.g., lighting, obstructions); etc. The computer system can check whether each of these parameters match a predefined parameter corresponding to a verified camera setup. Based on these parameters, the computer system can elect whether to verify the camera setup. If the computer system cannot verify the camera setup of the user (e.g., the computer system detects a non-compliant camera setup), the computer system can prompt the user to adjust the camera setup including adjusting any of these parameters until the camera setup is verified.

In one implementation, the computer system can compare an image extracted from the video feed of the user to a model image representing ideal image parameters corresponding to a verified camera setup. For example, the computer system can: access an image of the user (and the user's surroundings) recorded by the camera; access the model image; characterize a difference between the image of the user and the model image; in response to the difference falling below a threshold difference, verify the camera setup of the user; and, in response to the difference exceeding a threshold difference, prompt the user to adjust the camera setup based on the difference.

The computer system can verify the camera setup of the user at set times and/or intervals to regularly confirm correct camera setup. For example, the computer system can verify the camera setup of the user each time the user logs into her computing device. In another example, the computer system can verify the camera setup of the user each morning when the user begins her work day. In yet another example, the computer system can verify the camera setup at set intervals (e.g., once every hour, once every day, once every week).

If the computer system cannot verify the camera setup of the user, the computer system can implement a series of strategies in order to verify the camera setup of the user and to encourage the user to implement the model camera setup. In one implementation, the computer system can select a strategy for verifying the camera setup of the user based on a quantity of detected instances of a non-compliant camera setup. For example, at an initial time, if the computer system cannot verify the camera setup of the user, the computer system can prompt the user to adjust the camera setup. At a second time succeeding the first time (e.g., 10 minutes later, 1 hour later) the computer system can again attempt to verify the camera setup of the user. If, at the second time, the computer system again cannot verify the camera setup of the user, the computer system can again prompt the user to adjust the camera setup and include a warning that a manager may be notified if the user does not implement the model camera setup. At a third time succeeding the second time, if the computer system still cannot verify the camera setup of the user, the computer system can: notify the user of a failed attempt to verify the camera setup; extract a brief video (e.g., 10 seconds) or static image of the user; and deliver this video or static image to the user's manager for manual inspection. Therefore, the computer system can build the user's trust in the computer system by enabling the user to correct this error (e.g., the camera setup) on her own before alerting her manager, and intelligently escalate a response and/or consequences of improper camera setup by the user.

### 6. Detecting Non-Compliant Behavior

The computer system can detect instances of non-compliant behavior by the user via the user video feed. For example, the computer system can detect: a mobile device in view of the camera and aimed at the user's computer display (e.g., such as to capture a photo of content rendered on the display); a second user in view of the camera; absence of the user from the video feed; a different user in replacement of the user; the user interacting with her mobile device for more than a threshold duration; the user taking notes on a piece of paper (e.g., such as to copy content rendered on the display); etc.

In one implementation, the computer system can access a compliance model linking features extracted from user video feeds to instances of non-compliant behavior to interpret instances of non-compliant behavior. For example, the computer system can: access a subset of frames from the video feed of the user; extract a set of features from the subset of frames; access a compliance model linking features extracted from user video feeds to instances of non-compliant behavior; and interpret a first instance of non-compliant behavior based on the set of features and the compliance model. In this implementation, the computer system can implement machine learning and/or computer vision methods and techniques to detect anomalies (e.g., a second user, an obstruction blocking a view of the camera, absence of the user) in frames of the video feed.

In this example, the computer system can implement artificial intelligence and computer vision techniques (e.g., template matching, object recognition) to detect objects and features indicative of non-compliant behavior in the video feed, such as: a smartphone facing a display; a second face; a user writing on a notepad (e.g., when credit card information is rendered on the display); etc.

In response to detecting an instance of non-compliant behavior, the computer system can access a compliance protocol to select an appropriate response and/or action matched to the instance of non-compliant behavior for the user. For example, responsive to detection of an instance of non-compliant behavior, the computer system can: prompt and/or warn the user of the detected instance of non-compliant behavior and/or confirm termination of the instance of non-compliant behavior within a threshold duration; serve the video feed of the user to a set of other users (e.g., coworkers of the user); and/or inform the user's manager of the instance of non-compliant behavior.

### 6.1 Characterizing Risk

The computer system can characterize risk (or “a risk score”) associated with an instance of non-compliant behavior based on characteristics of the instance of non-compliant behavior.

In one implementation, the computer system can characterize a risk score associated with an instance of non-compliant behavior based on a type of content (e.g., public information, company data, medical records, financial records, banking information) rendered on a display of the computing device accessed by the user. More specifically, in response to interpreting a first instance of a non-compliant behavior, the computer system can: access a set of content characteristics representative of a type of content rendered on a display of the computing device accessed by the user; and characterize a risk score associated with the first instance of the non-compliant behavior based on the set of content characteristics (e.g., the type of content rendered on the display). For example, the computer system can: characterize a first risk score for a first instance of non-compliant behavior (e.g., of a first type) as “low risk” based on content rendered on the display of the computing device including publicly available information; and characterize a second risk score for a second instance of non-compliant behavior (e.g., of the first type) as “high risk” based on content rendered on the display of the computing device including confidential medical records.

In another implementation, the computer system can characterize a risk score associated with an instance of non-compliant behavior based on a type of non-compliant behavior detected during this non-compliant event. More specifically, in response to interpreting a first instance of a non-compliant behavior, the computer system can: identify a type of non-compliant behavior (e.g., based on features extracted from frames of the user video feed); and characterize a risk score for the first instance of the non-compliant behavior based on the type of non-compliant behavior. For example: the computer system can characterize a first risk score of ninety percent for a first instance of non-compliant behavior corresponding to detection of the user capturing photos of the display of the computing device with a camera of her mobile phone; and characterize a second risk score of five percent for a second instance of non-compliant behavior corresponding to the user interacting with her mobile phone—the camera aimed downward and/or away from the display of the computing device—for less than a threshold duration (e.g., 1 minute).

In yet another implementation, the computer system can characterize a risk score associated with an instance of non-compliant behavior based on both the type of content rendered on the display of the computing device accessed by the user and a type of non-compliant behavior associated with the instance of non-compliant behavior. In this implementation, in response to interpreting a first instance of a non-compliant behavior, the computer system can: identify a type of content rendered on the display of the computing device accessed by the user; identify a type of non-compliant behavior (e.g., user absence, second user in video feed, camera obstruction); and characterize a risk score for the for the first instance of the non-compliant behavior based on the type of content and the type of non-compliant behavior.

For example, the computer system can: characterize a first risk score of ninety percent for a first instance of non-compliant behavior corresponding to detection of a second (adult) user in the video feed of the user while sensitive and/or confidential information is rendered on the display of the computing device accessed by the user; characterize a second risk score of fifty percent for a second instance of non-compliant behavior corresponding to detection of a second (adult) user in the video feed of the user while non-sensitive and/or nonconfidential information is rendered on the display of the computing device accessed by the user; characterize a third risk score of ten percent for a third instance of non-compliant behavior corresponding to detection of a child in the video feed of the user while sensitive and/or confidential information is rendered on the display of the computing device accessed by the user; and characterize a fourth risk score of less than five percent for a fourth instance of non-compliant behavior corresponding to detection of a child in the video feed of the user while non-sensitive and/or nonconfidential information is rendered on the display of the computing device accessed by the user. The computer system can access the compliance protocol to select a response for each of these instances of non-compliant behavior based on the corresponding risk score. Therefore, the computer system can intelligently identify instances of non-compliant behavior posing the greatest risk and thus minimize efforts and/or resources spent investigating instances of non-compliant behavior of relatively low risk.

### 6.2 Response to Non-Compliant Behavior

The computer system can leverage the risk score associated with an instance of non-compliant behavior to inform selection of an action according to the compliance protocol. For example, the computer system can: discard an instance of non-compliant behavior corresponding to a risk score below a threshold risk; and flag an instance of non-compliant behavior corresponding to a risk score above the threshold risk for further review at a later time. In another example, the computer system can: discard an instance of non-compliant behavior corresponding to a risk score below a lower threshold risk; warn the user of an instance of non-compliant behavior corresponding to a risk score above the lower threshold risk and below an upper threshold risk and/or record a short video including the instance of the non-compliant behavior; and notify a manager of an instance of non-compliant behavior corresponding to a risk score above the upper threshold risk and/or immediately serve a video feed of the user to the manager.

In one implementation, in response to detecting an instance of non-compliant behavior, the computer system can automatically trigger the camera to record a short video (e.g., 10 seconds, 30 seconds, 1 minute) of the user to capture the instance of the non-compliant behavior within the short video; and store this short video of the user and the instance of non-compliant behavior in a user profile associated with the user, such as locally on the computing device and/or remotely in a remote database. The computer system can save and/or flag these short videos for further investigation (e.g., by a manager).

In one implementation, the computer system can intelligently identify instances of non-compliant behavior to prioritize according to risk associated with these instances of non-compliant behavior. For example, the computer system can generate an ongoing list of instances of non-compliant behavior to review which a manager may access at an instance of a manager portal. The computer system can rank instances of non-compliant behavior according to risk score, such that the manager reviews instances of non-compliant behavior with the highest risk score first. In another example, the computer system can directly notify a manager of an instance of non-compliant behavior corresponding to a particular high risk score. Therefore, by highlighting instances of non-compliant behavior associated with the highest risk to the manager, the computer system enables the manager to prioritize review of non-compliant behavior which may be most threatening and/or malicious and thus allocate resources to investigating these instances accordingly.

### 7. User Profile

The computer system can track instances of non-compliant behavior for the user over time and store information related to these instances of non-compliant behavior within a user profile (e.g., at a remote database). For example, for each instance of non-compliant behavior detected for the user, the computer system can: store a recorded image or video (e.g., a 10-second video) of the instance of non-compliant behavior at the user profile; store a risk score associated with non-compliant behavior at the user profile; store a type of non-compliant behavior associated with the instance of non-compliant behavior; etc. Therefore, the computer system can leverage data recorded for users over time to detect users exhibiting frequent and/or recurring instances of non-compliant behavior.

In one implementation, the computer system can store and update a count corresponding to a number of instances of non-compliant behavior associated with the user. The computer system can leverage this count to select an action responsive to detection of instances of non-compliant behavior for the user. For example, in response to detecting an instance of non-compliant behavior for a user, the computer system can: access a user profile corresponding to the user; extract a count corresponding to a number of instances of non-compliant behavior exhibited by the user within a threshold period of time (e.g., within the last week, within the last 30 days, within the last year); and update the count to reflect the latest instance of non-compliant behavior. In response to the count falling below a threshold count, the computer system can select an action—from the compliance protocol—matched to a risk score associated with the instance of non-compliant behavior. However, in response to the count exceeding the threshold count, the computer system can: flag the user as exhibiting non-compliant behavior; and prompt further investigation of this user by a third-party user (e.g., a manager of the user, a security administrator).

In another implementation, the computer system can store and update a compliance score for the user and leverage this compliance score to select an action responsive to detection of instances of non-compliant behavior for the user. For example, in response to detecting an instance of non-compliant behavior for a user, the computer system can: access a user profile corresponding to the user; extract a series of non-compliant behavior characteristics (e.g., types of non-compliant behavior, a set of risk scores associated with instances of non-compliant behavior, a count of instances of non-compliant behavior) corresponding to a series of instances of non-compliant behavior recorded within a threshold duration; update the series of non-compliant behavior characteristics to reflect the latest instance of non-compliant behavior; and calculate a compliance score for the user representing behavior of the user within a period of time corresponding to the threshold duration. In response to the compliance score exceeding a threshold compliance, the computer system can select a response to the instance of non-compliant behavior—from the compliance protocol—matched to a risk score associated with the instance of non-compliant behavior. However, in response to the compliance score falling below the threshold compliance, the computer system can: flag the user as exhibiting non-compliant behavior; and prompt further investigation of this user by a third-party user (e.g., a manager of the user, a security administrator).

### 8. Variation: Forward-Facing Camera+Side-Facing Camera

In one variation, the computer system can interface with a set of cameras arranged within the user's working space (e.g., office, home) over a computer network (e.g., the Internet) to collect user video feeds of remote users for distribution to other users and/or for monitoring non-compliant behaviors of users. In this variation, the computer system can selectively access a forward-facing camera and a side-facing camera of the user to collect and distribute a forward-facing video feed and a side-facing video feed of the user. For example, the computer system can interface with a forward-facing camera integrated into a computer of the user or a monitor over a display of the computing device accessed by the user, such that the forward-facing camera captures a video feed of a face of the user viewing the display of the computing device. Alternatively, the computer system can interface with a forward-facing camera integrated into a peripheral device mounted to the computer or the monitor over the display of the computing device accessed by the user. The computer system can selectively collect a forward-facing video feed of the user from the forward-facing camera—such that the forward-facing video feed captures the face of the user viewing a display of the computer. Additionally, the computer system can interface with a side-facing camera to capture side-facing video feeds of the user. For example, the computer system can interface with a side-facing camera integrated into a peripheral device mounted to a boom—mounted to a back of the computer monitor and extending longitudinally from a side of the computer monitor toward the user—to locate a side of the user's head in the field of view of the side-facing camera as the user views the display. Therefore, the computer system can interface with both forward-facing and side-facing cameras to collect forward-facing and side-facing video feeds of the user while working remotely and in view of the cameras.

In one implementation, the computer system can prioritize a video feed of the forward-facing camera for monitoring compliance of users and access the side-facing camera for further investigation of detected instances of non-compliant behavior. For example, the computer system can: access a first video feed of the user captured by a forward-facing camera coupled to a computing device of the user; extract a first set of features from a first subset of frames of the first video feed; and, in response to detecting motion adjacent an edge of the first subset of frames, access a second video feed of the side-facing camera to further investigate. Then, in response to detecting a second user standing next to the user in a subset of frames of the second video feed, the computer system can confirm detection of an instance of non-compliant behavior corresponding to the second user's presence in the second video feed recorded by the side-facing camera. Therefore, the computer system can leverage both forward-facing and side-facing video feeds to confirm instances of non-compliant behavior and extract further insights into instances of non-compliant behavior detected in one of the feeds.

In another implementation, the computer system can prioritize a video feed of the side-facing camera for users exhibiting compliant behavior (e.g., over a period of time). For example, in response to a user achieving a compliance score exceeding a threshold compliance score, the computer system can prioritize the video feed of the side-facing camera for this user for a set period of time. However, if the user's compliance score falls below the threshold compliance within this set period of time, the computer system can switch to prioritizing a video feed of the forward-facing camera. Therefore, the computer system enables users to earn more autonomy by building trust and exhibiting compliant behavior over time.

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for monitoring non-compliant behaviors of employees in a distributed workforce, the method comprising, during a work period:
accessing a video feed of a user captured by a camera coupled to a computing device operated by the user;
at a first time during the work period, extracting a first set of features from a first subset of frames of the video feed;
detecting a first instance of non-compliant behavior based on the first set of features extracted from the first set of frames;
identifying a type of non-compliant behavior associated with the first instance of non-compliant behavior;
accessing a set of content characteristics representing a type of content rendered on a display of the computing device during the first instance of non-compliant behavior;
characterizing a risk score of the first instance of non-compliant behavior based on the type of non-compliant behavior and the type of content rendered on the display; and
in response to the risk score exceeding a threshold risk, flagging the first instance of non-compliant behavior for investigation.

2. The method of claim 1, further comprising, in response to the risk score falling below the threshold risk, transmitting a warning to the user regarding the first instance of the non-compliant behavior.
